(19) United States
(12) Patent Application Publication
(10) Pub. No.: US 2007/0211908 A1
(43) Pub. Date: Sep. 13, 2007

(54) MULTI-CHANNEL AUDIO CONTROL

(75) Inventor: Kristof Van Reck, Boom (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,500

(22) PCT Filed: Sep. 20, 2005
(86) PCT No.: PCT/IB05/53083

§ 371 Date: Mar. 19, 2007

(30) Foreign Application Priority Data
Sep. 22, 2004 (EP) 04104597.2

(51) Int. Cl. H04B 3/00

(52) U.S. Cl. 381/80

(57) ABSTRACT

A multi-channel audio device (1) comprises an amplification unit (2) for amplifying respective audio signals of the channels and a control unit (3) for controlling properties of the audio signal so as to produce a multi-channel listening area (10) or “sweet spot”. The control unit (3) is arranged for continually moving the multi-channel listening area (10) between a first location (I) and a second location (II), such that two or more listeners may alternatingly be located in a multi-channel listening area (10).

### FIELD OF THE INVENTION

The present invention relates to multi-channel audio control. More in particular, the present invention relates to a multi-channel audio device and method which allow the location of a multi-channel listening area to be controlled.

### BACKGROUND OF THE INVENTION

Various multi-channel audio systems are known, of which traditional stereo systems have two channels with corresponding transducers (such as loudspeakers), which channels together form the audio sound. By controlling the sound level and/or other audio parameters or properties, a virtual audio source can be produced, which virtual audio-source is typically located between the transducers. To fully appreciate the spatial effects of stereo, the listener should be located in an area approximately halfway between the transducers, outside this area one of the two channels will be dominant and the stereo effect will be lost.

Modern audio systems typically have five or six channels, which channels together form the audio sound. In a so-called “5.1” multi-channel audio system five regular channels and one auxiliary (bass) channel are provided. Such systems are capable of producing a greatly enhanced spatial effect but the effective listening area, also known as “sweet spot”, is relatively small. Such a small listening area forces the listener to remain in a limited area in order to fully appreciate the spatial effects. In addition, two or more listeners will have to be very close together to benefit from the advantages of the multi-channel audio system. It will be clear that this is often undesirable.

U.S. Pat. No. 6,307,941 discloses a system and method in which one or more spatial clues of an audio signal may be modulated to increase the clarity and the perceived localization of a virtual sound image. These clues may be varied at below the just noticeable level to cause the virtual source location to move slightly relative to the listener's head. In addition, the system of above-mentioned U.S. Pat. No. 6,307,941 involves relatively complicated circuitry, such as circuits for cross-talk cancellation.

### OBJECT AND SUMMARY OF THE INVENTION

It is an object of the present invention to provide a multi-channel audio device which provides multiple multi-channel listening areas.

It is another object of the present invention to provide a method of controlling a multi-channel audio device, which method provides multiple multi-channel listening areas.

Accordingly, the present invention provides a multi-channel audio device, comprising amplification means for amplifying respective audio signals of the channels, and control means for controlling properties of the audio signals so as to produce a multi-channel listening area, wherein the control means are arranged for continually moving the multi-channel listening area between a first location and a second location.

By providing a multi-channel listening area which is moved between locations, it is possible to have a multi-channel listening area, and hence full appreciation of the multi-channel audio, at each location. By continually moving the multi-channel listening area, each location is served in turn.

In other words, accordingly, it is advantageously possible for two or more listeners who are spaced apart to fully appreciate the benefits of multi-channel audio.

In another aspect it has been found that no complicated circuitry is needed, such as circuits for cross-talk cancellation, which cross-talk cancellation may also introduce artifacts. Hence advantageously costs of the audio device may be reduced and artifacts may be avoided.

The control means control properties or parameters of the audio signals, such as the respective levels and/or delay times of the channels. More in particular, the control means may control the amplification means so as to produce a multi-channel listening area. In other words, the control means may control at least the gains of the multiple channels so that a multi-channel listening area is created in a particular location. This gain control may be direct and include varying the gains of the individual amplifiers, or indirect and involve multipliers or other amplitude control elements for varying the amplitudes of the channels, preferably prior to amplification. In digital embodiments, the control means may comprise a digital signal processor or a microcontroller.

It is possible for two locations, or the multi-channel listening areas at the respective locations, to overlap partially, thus creating a single enlarged multi-channel listening area covering two locations. However, this still restrains the locations and hence the positions of the listeners. It is therefore preferred that the first location and the second location are non-overlapping. That is, the control means may be arranged for providing multi-channel listening areas at distinct locations that have no mutual overlap.

In a first embodiment, the device of the present invention is arranged in such a way that the movement of the multi-channel listening area is substantially instantaneous. In this embodiment, therefore, the multi-channel listening area is moved between locations without covering any intermediate area. This embodiment maximizes the time duration of the multi-channel listening area at each location.

In a second embodiment, the movement of the multi-channel listening area is gradual. That is, the multi-channel listening area gradually moves from one location to the next, thus covering the area in between these locations.

The frequency at which the multi-channel listening area switches locations may vary. However, it is preferred that the multi-channel listening area is moved between the locations at a frequency of less than 1 Hz (hertz), in particular less than 0.5 Hz. In a further embodiment, this frequency is less than 0.25 Hz. It will be understood that a (switching) frequency of 0.5 Hz means that a cycle in which the multi-channel listening area is moved to all locations takes two (2) seconds. It is further preferred that the switching frequency is user controlled.

A multi-channel listening area may be moved by varying one or more audio parameters of one or more channels, including the level (amplitude), the delay time, and other parameters. In the present invention, however, it is preferred that the multi-channel listening area is moved by varying the sound level only. This allows a very simple and economic control of the channels while avoiding the artifacts typically introduced by more complex techniques. As stated above, the sound levels of the channels may be varied by controlling the gains of the amplification means, but other techniques are also possible, such as using multipliers. In addition to merely adjusting the levels (gains) of the channels, remixing of some or all of the channels may be used to move the multi-channel listening area.

In a further aspect it may be possible that the variation in sound level effecting the movement of the multi-channel listening is barely noticeable for a listener, or not noticeable at all. This would result in a “subconscious” movement of the multi-channel listening area. However, according to a further aspect of the present invention, the variation in the sound level may be noticeable. That is, in a further embodiment of the present invention the listener can hear the multi-channel listening area move. It has surprisingly been found that this audible movement is typically not perceived as an artifact but, instead, as an advantageous feature. Of course the perception of the movement depends on the listener and the frequency at which the multi-channel listening area is moved (switching frequency).

The device of the present invention may move the multi-channel listening area between two locations, as discussed above. However, the present invention is not so limited and in a further embodiment the control means are arranged for continually moving the multi-channel listening area between the first location, the second location and at least one further location. The multi-channel listening area may therefore be moved over three, four, five or even more than five locations, all of which may be distinct or may partially overlap.

In a further advantageous embodiment, the device comprises position determination means for determining the positions of transducers coupled to the device. These position determination means may be user-operated, for example the user manually entering the positions of the transducers, or fully automatic, for example the transducers each producing a test sound in turn and receiving the test sounds of the other transducers.

The present invention also provides an audio system comprising a device as defined above.

The present invention additionally provides a method of controlling a multi-channel listening area produced by a multi-channel audio device, the method comprising the step of continually moving the multi-channel listening area between a first location and a second location.

The present invention also provides a computer program product for carrying out the method as defined above. A computer program product may comprise a data carrier, such as a CD or DVD, on which a computer program is recorded. The computer program consists of a plurality of program steps which may be carried out by a generic computer or a special purpose computer.

### BRIEF DESCRIPTION OF THE DRAWINGS

The present invention will further be explained below with reference to exemplary embodiments illustrated in the accompanying drawings, in which:

FIG. 1 schematically shows an audio arrangement having two possible multi-channel listening areas.

FIG. 2 schematically shows an audio arrangement according to the present invention having two virtually simultaneous multi-channel listening area.

FIG. 3 schematically shows a first embodiment of an audio device according to the present invention.

FIG. 4 schematically shows a second embodiment of an audio device according to the present invention.

FIG. 5 schematically shows an audio system comprising an audio device according to the present invention.

### DESCRIPTION OF EMBODIMENTS

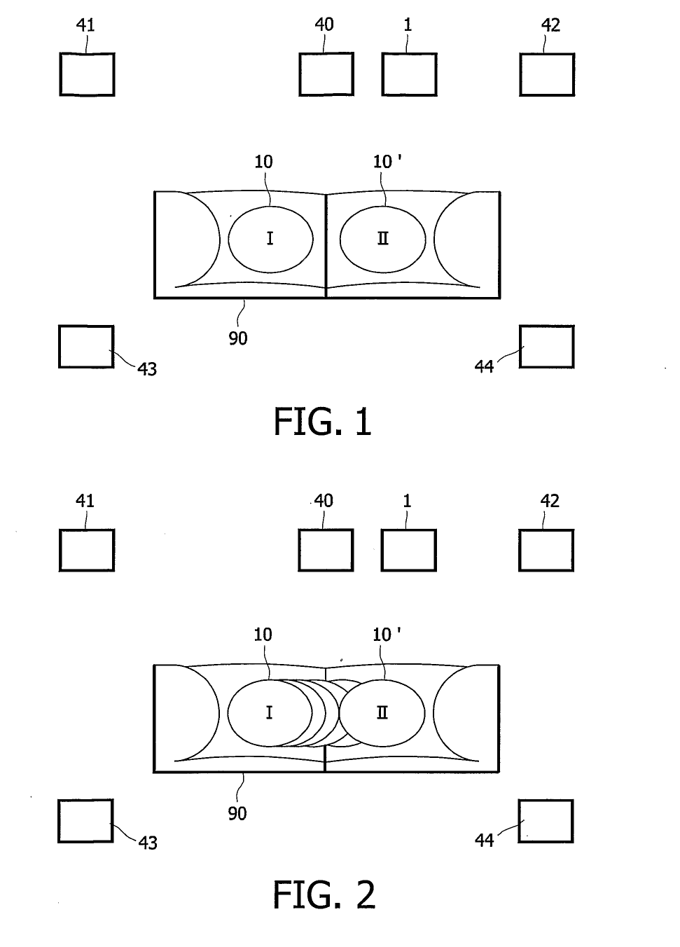

The audio arrangement shown merely by way of non-limiting example in FIG. 1 comprises an audio device 1 and a set of transducer units 40-44. Multi-channel listening areas 10 and 10′ are shown to be located at furniture item 90, which item 90 is a sofa in this case.

The transducer units 40-44, which are coupled to the audio device 1, may each comprise one or more transducers, such as loudspeakers. In the embodiment shown, five transducer units are used: central unit 40, left unit 41, right unit 42, left rear unit 43 and right rear unit 44. Together these units 40-44 form a sound pattern which results in a multi-channel listening area or “sweet spot” 10 in location I. In this multi-channel listening area, the “surround” effect of the audio arrangement can be heard, including the spatial properties of the arrangement. Outside the multi-channel listening area, the spatial properties are at least partially lost as the proper balance of the signals produced by the transducer units is not available.

It is noted that the multi-channel listening area 10 would typically be located in the center of an area or base defined by the transducers 40-44, in FIG. 1 near the middle of furniture item 90. Using suitable audio adjustment techniques known per se, such as amplitude panning, the multi-channel listening area 10 can be repositioned to the location I shown in FIG. 1.

As can be seen from FIG. 1, a listener situated in location I would be in the multi-channel listening area 10 and would therefore be able to appreciate the full benefits of the audio arrangement, in particular the spatial properties of this arrangement. Another listener, situated in location II, would not be inside the multi-channel listening area 10 and would therefore not be able to fully appreciate the features of the audio arrangement. Similarly, a listener moving from location I to location II would also move outside the multi-channel listening area 10. Accordingly, a multi-channel listening area 10′ would be required at location II. However, known amplitude panning techniques only create a multi-channel listening area at either location I or location II.

It is noted that in the example shown, the distance between the locations I and II is such that there would be no overlap between multi-channel listening areas 10 and 10′. This distance may be greater than merely required to prevent overlap, and could be greater than 0.5 m, 1.0 m or even 2.0 m. Such larger distances would make it even more difficult for two listeners to fully enjoy the multi-channel audio.

In accordance with the present invention, the multi-channel listening area is continuously moved from location I to location II and back, as is schematically illustrated in FIG. 2.

As a result of this continuous movement, the multi-channel listening area 10 occupies location I at one moment, and is subsequently moved to location II. This movement may be substantially instantaneous, but is preferably gradual, thus covering the area in between the locations I and II during the movement.

The gradual movement of the multi-channel listening area from location I to location II may be stepped or smooth. A stepped movement may involve one, two, three or more distinct intermediary locations (in FIG. 2, four intermediary locations are illustrated), while a smooth movement has no distinct intermediary locations. To illustrate a possible embodiment of the movement of the multi-channel listening area, a stepped example will be used.

In step 0 (initial position), the multi-channel listening area is fully (100%) at the first location I, and not at the second location II. In step 1 (first step), the intensity of the multi-channel listening area at the first location is reduced to 80%, while the intensity of the multi-channel listening area at the second location is increased. In step 2, intensity at first location I is further reduced to 60%. After step 5 the multi-channel listening area is at the second location II.

Accordingly, the present invention provides a shift of the multi-channel listening area from a first location I to a second, distinct location II. In fact, the multi-channel listening area moves back and forth between two or more locations (it is noted that the multi-channel listening area could move between three, four or more locations). The speed of the movement is determined by the frequency at which the multi-channel listening area switches locations. This switching frequency may be 1 Hz or less, for example 0.5 Hz, 0.4 Hz, 0.25 Hz or 0.1 Hz. A switching frequency of 0.25 Hz implies that the multi-channel listening area completes a full cycle in four (4) (=1/0.25) seconds, a full cycle being a movement from the first location to the second (or further) location and back. The frequency may be set by the user, but may also be automatically adjusted by the device 1. Embodiments can be envisaged in which the switching frequency is dependent on the content of the audio signal. A song with a quick beat may in such embodiments produce a higher switching frequency than a relatively slow romantic or classical piece.

At each location (I and II in FIGS. 1 and 2), a listener has the impression that the multi-channel listening area is situated at that particular location. The movement of the multi-channel listening area may be audible, but it has been found that this in not experienced as an artifact. Instead, many listeners appreciate this additional sound effect. This is in particular the case when the center channel (transducer 40 in FIGS. 1 and 2) is left unchanged, the movement of the multi-channel listening area being effected by a suitable manipulation of the other channels (corresponding with transducers 41-44 in FIGS. 1 and 2).

The movement of the multi-channel listening area is automatic, but may be adjusted by a user. A user could for example adjust the switching frequency, set the locations (I and II in FIGS. 1 and 2), and make other adjustments. It can also be envisaged that the locations have different “weights”, the multi-channel listening area staying longer in one location than in another (for example 60% and 40%, instead of 50% each).

Although the movement may be linear, as illustrated in FIG. 2, the invention is not so limited and a curved movement may be provided. Alternatively, or additionally, a rotation of the multi-channel listening area may be provided.

The terms “area” and “multi-channel listening area” refer to a two-dimensional arrangement, that is, an arrangement in which all transducers may be considered to be located in a single plane. The invention, however, is not so limited and may also be applied in situations where a “space” or “multi-channel listening space” is provided using a three-dimensional transducer arrangement. The term “area” will be used here to refer to both types of arrangement.

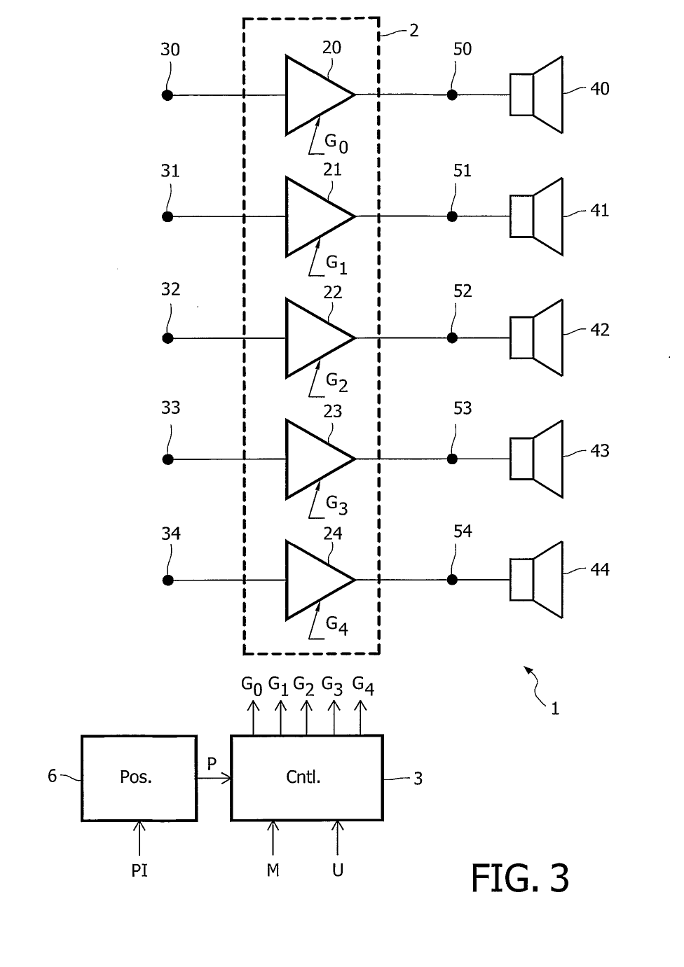

An embodiment of the device according to the present invention is schematically illustrated in FIG. 3. The merely exemplary device 1 comprises an amplifier unit 2, a control unit 3 and a positioning unit 6. The device 1 receives multi-channel audio signals via input terminals 30-34, and outputs amplified audio signals via output terminals 50-54, to which output terminals 50-54 transducers 40-44 are coupled respectively.

The amplifier unit 2 comprises, in the embodiment shown, five controlled amplifiers 20-24 coupled to the input terminals 30-34, that is one amplifier for each channel of the multi-channel audio signal to be rendered. The gain of each amplifier 20-24 is controlled by a respective gain G₀-G₄ produced by the control unit 3.

The control unit 3 is, in a preferred embodiment, capable of operating in two modes: a first mode in which all gains G₀-G₄ all have substantially the same value (for example the value 1), and a second mode in which the gains G₀-G₄ are continuously altered to effect the apparent movement of the multi-channel listening area. Either mode may be selected by a mode control signal M which may be supplied by a user, for example by operating a suitable button on a remote control device (not shown). The control unit 3 may further be capable of receiving a user control signal U, a positioning signal P, and an overall volume control signal (not shown).

The user control signal U, which may also be produced by a remote control unit and be transferred to the control unit using infra-red or other suitable wireless technology, may set the switching frequency (that is, the frequency at which the multi-channel listening area is moved between the desired locations) and other user parameters.

The position signal P is produced by the positioning unit 6 and indicates the locations (I and II in FIGS. 1 and 2) the multi-channel listening area is to cover. To this end, the positioning unit 6 receives position-related information PI from a remote control unit or another suitable source. This position-related information PI may relate to the respective positions of the transducers 40-44 and the desired multi-channel listening area locations, and may be obtained using any suitable technique. For example, the loudspeakers could each produce a test signal that would be recorded by the remote control unit and transferred to the positioning unit. The arrival times of these test signals would provide clues as to the distances of the transducers relative to the remote control unit. By carrying out this test in both desired locations, the positioning unit 6 would “know” the distances of the transducers relative to all desired listening locations. Such a technique is described in the document US 2003/0031333 “System and method for optimization of three-dimensional audio”, in particular in connection with FIG. 8 thereof, the disclosure of which is hereby incorporated by reference.

Alternatively, or additionally, a representative information of spatial position of a respective transducer 40-44 and of the listener may be shown on a television apparatus or computer screen. Indicating means may be provided there for enabling a user to indicate the spatial positions of the transducers and/or listener among each other and for providing said position-related information PI on basis of the positions of the transducers and/or listener indicated. By virtually moving these positions on the screen, suitable sound adjustments may be made at the audio arrangement.

The control unit 3 uses the position related information PI for controlling the gains G₀-G₄ in such a way that the multi-channel listening area produced by the audio channels is automatically moved between the desired locations I, II. In the embodiment of FIG. 3, such a controlling is accomplished by varying the gains only. Of course it would be possible to also vary other audio signal characteristics, such as delay times, but such techniques are likely to introduce artifacts. Varying the gains only to move the multi-channel listening area is relatively simple and economical. In the embodiment of FIG. 3 there is no cross-talk cancellation implemented as this would typically also introduce artifacts.

It is noted that in typical five-channel systems, such as 5.1 systems, the sound level of the central transducer 40 (see FIGS. 1 and 2) may remain constant. That is, the central transducer 40 may not be involved in moving the multi-channel listening area. Accordingly, the gain control signal G₀ may be constant and, for example, equal to one. In some embodiments, therefore, the amplifier 20 corresponding with the central transducer 40 may be omitted and replaced by a through connection.

It is further noted that the amplifiers 20-24 of FIG. 3 may be replaced with other elements, such as multipliers for multiplying each audio channel by a corresponding gain G₀-G₄. The actual way in which the amplitudes of the channels are controlled so as to achieve a moving multi-channel listening area is not essential to the invention. In addition to, or instead of, controlling the amplitudes of the channels, controlled delays may be used. The amplifiers 20-24 could therefore be replaced with controlled delay elements.

In addition to the components shown, the audio device 1 may further comprise filters, additional amplifiers (such as power amplifiers arranged in series with the amplifiers 20-24), one or more power supplies and/or other components which are not illustrated in FIG. 3 for the sake of clarity of the drawing. The device 1 may incorporate other components so as to form a complete amplification unit, or may be designed as a pre- or post-processing unit for use in conjunction with a conventional amplifier unit.

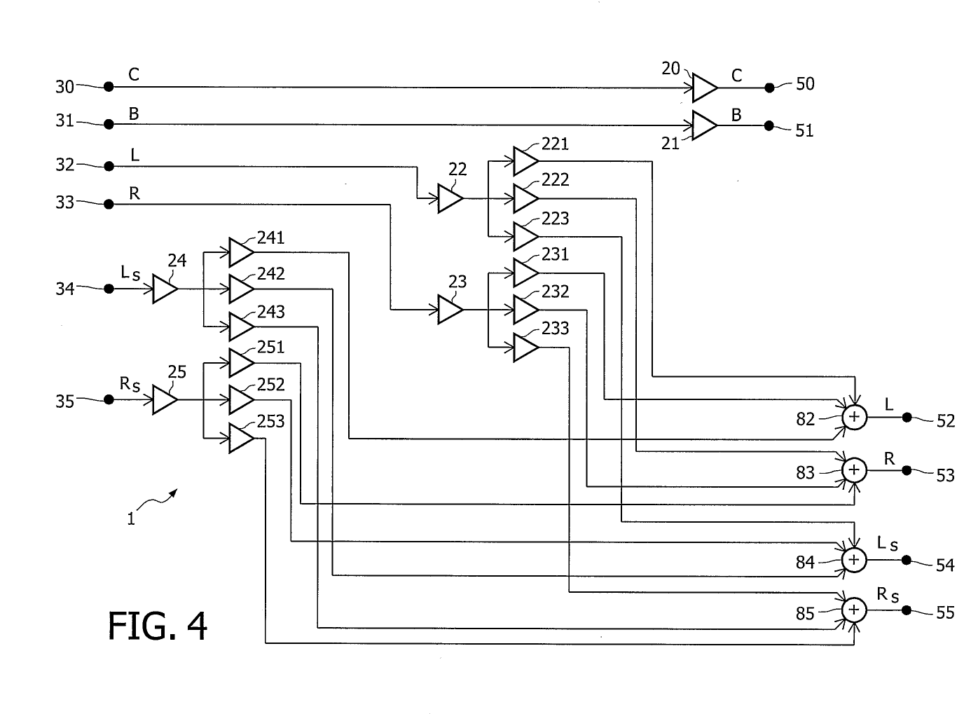

An alternative embodiment of the device 1 of the present invention is schematically illustrated in FIG. 4. The embodiment of FIG. 4 is designed for remixing the channels, as an alternative for, or in addition to, the amplitude control scheme of FIG. 3.

In the exemplary embodiment of FIG. 4 six channels are used: a center channel C, a bass (subwoofer or “0.1”) channel B, a left channel L, a right channel R, a left surround channel Ls, and a right surround channel Rs, which are received at input terminals 30-35 respectively. After a suitable remixing, these channels are output at output terminals 50-54.

In the embodiment shown, the center channel C and the bass channel B are not remixed. Instead, they may be amplified by amplifiers 20 and 21 respectively, as in FIG. 3. All amplifiers shown in FIG. 4 may have a variable gain which is controlled by a suitable control unit (3 in FIG. 3). Not remixing the center channel C has the advantage that the movement of the multi-channel listening area is not perceived as an artifact. The low frequencies of the bass channel B contribute little to the perceived direction of the sound and remixing the bass channel is therefore not essential.

The left channel L is first amplified in amplifier 22, as in FIG. 3, and this amplification may involve a gain control. Then the amplified left channel signal is fed to three parallel amplifiers 221, 222 and 223 coupled to adding units 82, 83 and 84 respectively, to contribute to the right channel R, the left channel L and the left surround channel Ls (that is, to the two adjacent channels and itself). The gains of these amplifiers 221-223 are controlled by a control unit (not shown in FIG. 4) to achieve a suitable (re-)mixing of the channels, resulting in a desired movement of the multi-channel listening area. It is noted that in the embodiment shown, each channel is remixed into itself and the two immediately adjacent channels, but not into the opposite channel (compare FIGS. 1 and 2 where the left channel L, reproduced by transducer 41, has adjacent channels R and Ls reproduced by transducers 42 and 43 respectively, while the opposite channel Rs is reproduced by transducer 44).

Similarly, the right channel R is remixed using the amplifier 23 for providing an overall gain adjustment, and the further amplifiers 231, 232 and 233 for selectively adding the right channel R to the channels L, R and Rs so as to effect a movement of the multi-channel listening area. The surround channels Ls and Rs are processing in the same manner. The resulting remixed channels are output at output terminals 50-55.

It will be understood that instead of gain controlled amplifiers, fixed-gain amplifiers and signal multipliers can be used, the multipliers being arranged for multiplying the audio channels by an adjustment (gain) signal. In digital embodiments, the gain adjustments and remixing may be carried out by a digital signal processor or a microcontroller. It will be clear to those skilled in the art that digital embodiments will require suitable A/D (Analog/Digital) and D/A (Digital/Analog) converters.

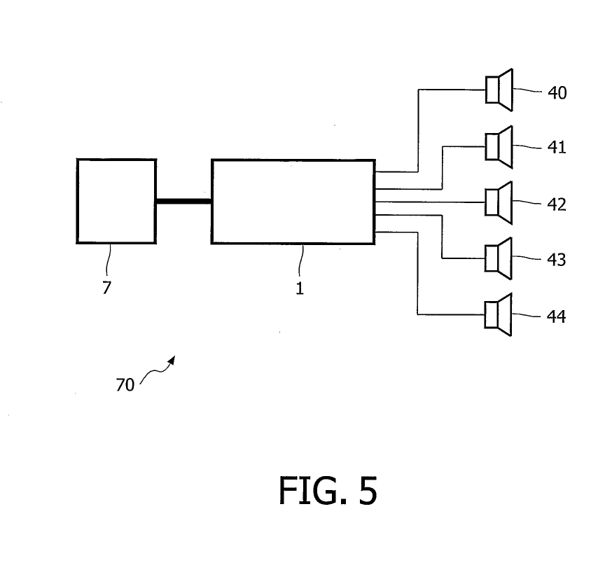

An audio system according to the present invention is schematically illustrated in FIG. 5. The exemplary audio system 70 comprises an audio source 7 coupled to an audio device 1 as defined above. A multi-wire, parallel cable may be used for coupling the audio source 7 and the audio device 1. Alternatively, a suitable wireless connection may be used. Transducers 40-44 are coupled to the audio device 1.

The audio source 7 may comprise a CD player, a DVD player, a desktop or laptop computer, a radio tuner, a television tuner, an internet terminal or any other audio source. The audio device 1 is arranged for automatically varying the position of the multi-channel listening area, as discussed above. The audio system 70 may further comprise additional components not illustrated in FIG. 5, such as additional transducers and/or additional audio sources.

The present invention is based upon the insight that two or more multi-channel listening areas 10, 10′ may be provided by producing a multi-channel listening area in alternate locations. The present invention benefits from the further insights that producing an multi-channel listening area in alternate locations may be accomplished by merely varying the sound levels of the channels, and that these variations in the sound levels may be audible.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents. The term multi-channel as used in this document refers to a device, system or method having multiple (that is, two or more) channels and includes, but is not limited to, the terms “stereo” and “5.1”.

It will be understood by those skilled in the art that the present invention is not limited to the embodiments illustrated above and that many modifications and additions may be made without departing from the scope of the invention as defined in the appending claims.

1. A multi-channel audio device (1), comprising amplification means (2) for amplifying respective audio signals of the channels, and control means (3) for controlling properties of the audio signals so as to produce a multi-channel listening area (10), wherein the control means (3) are arranged for continually moving the multi-channel listening area (10) between a first location (I) and a second location (II).

2. The device according to claim 1, wherein the first location (I) and the second location (II) are non-overlapping.

3. The device according to claim 1, wherein the movement of the multi-channel listening area (10) is gradual.

4. The device according to claim 1, wherein the movement of the multi-channel listening area (10) is substantially instantaneous.

5. The device according to claim 1, wherein the multi-channel listening area (10) is moved between the locations (I, II) at a frequency of less than 1 Hz, preferably less than 0.5 Hz, more preferably less than 0.25 Hz.

6. The device according to claim 1, wherein the multi-channel listening area (10) is moved by varying the sound level only, the control means (3) preferably being arranged for controlling the gains of the amplification means (2).

7. The device according to claim 6, wherein the variation in the sound level is noticeable.

8. The device according to claim 1, wherein the control means (3) are further arranged for continually moving the multi-channel listening area (10) between the first location (I), the second location (II) and at least one further location.

9. The device according to claim 1, further comprising position determination means (5) for determining the positions of transducers (40, . . . , 44) coupled to the device.

10. An audio system (70), comprising a multi-channel audio device (1) according to claim 1.

11. A method of controlling a multi-channel listening area (10) produced by a multi-channel audio device (1), the method comprising the step of continually moving the multi-channel listening area (10) between a first location (I) and a second location (II).

12. The method according to claim 11, wherein the first location (I) and the second location (II) are non-overlapping.

13. The method according to claim 11, wherein the movement of the multi-channel listening area (10) is gradual.

14. The method according to claim 11, wherein the movement of the multi-channel listening area (10) is substantially instantaneous.

15. The method according to claim 11, wherein the multi-channel listening area (10) is moved between the locations (I, II) at a frequency of less than 1 Hz, preferably less than 0.5 Hz, more preferably less than 0.25 Hz.

16. The method according to claim 11, wherein the multi-channel listening area (10) is moved by varying the sound level only.

17. The method according to claim 16, wherein the variation in the sound level is noticeable.

18. The method according to claim 11, wherein the multi-channel listening area is continuously moved (10) between the first location (I), the second location (II) and at least one further location.

19. The method according to claim 11, further comprising the step of determining the positions of transducers (40, . . . , 44) coupled to the device.

20. A computer program product for carrying out the method according to claim 11.
